(19) United States
(12) Patent Application Publication
(10) Pub. No.: US 2006/0150807 A1
(43) Pub. Date: Jul. 13, 2006

(54) Hydraulic control arrangement

(75) Inventors: Wolfgang Kauss, Francheville (FR); Didier Desseux, Solaize (FR)

Correspondence Address: OLIFF & BERRIDGE, PLC, P.O. BOX 19928, ALEXANDRIA, VA, 22320, US

(73) Assignee: BOSCH REXROTH AG, STUTTGART (DE)

(21) Appl. No.: 10/558,836

(22) PCT Filed: May 28, 2004
(86) PCT No.: PCT/EP04/05836

§ 371 Date: Jan. 23, 2006

(30) Foreign Application Priority Data
Jun. 4, 2003 (DE) 103 25 294.0

(51) Int. Cl. F15B 11/08

(52) U.S. Cl. 91/445

(57) ABSTRACT

A hydraulic control arrangement is disclosed for the load pressure independent control of a consumer, comprising a distribution valve forming an inlet metering orifice, a corresponding individual pressure compensator, a stop valve provided for each consumer connection which may be released by means of a pilot valve and an anti-cavitation valve by means of which pressure medium can be drawn from a reservoir to avoid cavitation. According to the invention, the distribution valve and the stop valves are arranged along two parallel axes, while the axes of the two pilot valves are arranged perpendicularly to these two axes. The anti-cavitation valves in turn extend perpendicularly to the axes of the distribution valves, the stop valves and the anti-cavitation valves.

The invention relates to a hydraulic control arrangement for the load-independent control of a consumer in accordance with the preamble of claim 1.

The basic structure of such a control arrangement is known, for instance, from WO 95/32364 A1. In this load pressure-independent flow distribution (LUDV)¹ system each consumer is provided with an adjustable metering orifice including a pressure compensator down the line, the latter keeping the pressure drop above the metering orifice constant so that the amount of pressure medium flowing to the respective hydraulic consumer is solely dependent on the opening cross-section of the metering orifice and not on the load pressure of the consumer or on the pump pressure. Since, for instance, in mobile working implements a plurality of such valve arrangements are connected in parallel, it is achieved by the pressure compensators of the system that, in the case that a hydro pump of the system has been adjusted up to the maximum stroke volume and the pressure medium flow is not sufficient to maintain the predetermined pressure drop above the metering orifices of the respective valve arrangements allocated to a consumer, the pressure compensators of all operated hydraulic consumers are adjusted in the closing direction so that all pressure medium flows are reduced by the same percentage. Due to this load-pressure independent flow distribution (LUDV) then all operated consumers move at a velocity reduced by the same percentage value. In the known solution it may occur when a consumer is supported for a quite long time that it drops due to a leakage flow via the distribution valve.
¹ German abbreviation (lastdruckunabhängige Durchflussverteilung)

This drawback is eliminated in a solution according to the data sheet RD 64 284/06.00 (hydro valves for mobile applications) by a releasable check valve which is inserted in the pressure medium flow path between the distribution valve and a consumer connection and which ensures the oil-leakage free shut-off thereof. In this known solution moreover a pressure/feed valve by which the consumer is protected against overload and against cavitation phenomena in the case of a lacking supply of the corresponding consumer connection with pressure medium.

In the solution known from FR 2,756 349 to each consumer connection a suction valve is allocated which extends perpendicularly to the plane of a valve disk accommodating the valve arrangement. This known solution lacks a stop valve for oil-leakage free shut-off of the consumer, however.

Compared to this, the object underlying the invention is to provide a hydraulic control arrangement in which all components required for controlling the consumer are combined in a compact manner in a valve housing portion, preferably a valve disk.

This object is achieved by a hydraulic control arrangement comprising the features of claim 1.

In accordance with the invention, the control arrangement is preferably integrated in a valve disk, wherein a distribution valve forming a LUDV metering orifice as well as two stop valves allocated to a consumer connection are located in the valve disk plane and two pilot valves allocated to the two stop valves are incorporated such that the axes thereof are oriented perpendicularly to the two axes of the distribution valve and of the stop valves. The pressure/anti-cavitation valve allocated to a consumer connection is arranged perpendicularly to the axes of the afore-described valve elements, i.e. perpendicularly to the disk plane. Moreover it is a particular feature of the invention that the pilot valves arranged perpendicularly to the axis of the distribution valve are actuated mechanically via a tappet which is axially movable by a slide valve of the distribution valve so as to release the stop valves and to permit discharge of pressure medium from the consumer.

The solution according to the invention excels by a special compactness, wherein all substantial components required in a LUDV system are accommodated in a minimum construction space.

Solutions in which the pilot valve is actuated mechanically via the slide valve of the distribution valve are known as such for instance from DE 196 27 306 A1 or U.S. Pat. No. 3,595,271 or U.S. Pat. No. 3,125,120. But these documents include no information about the compact structure according to the invention of a valve disk for a LUDV system.

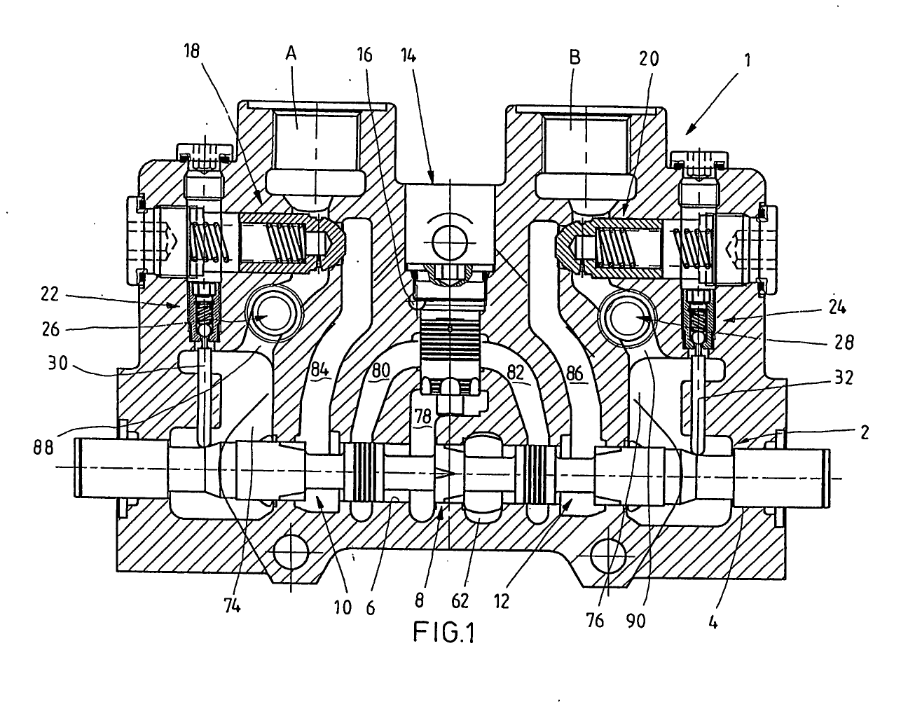

In a preferred embodiment of the invention the distribution valve, the stop valves and the pilot valves are arranged in parallel to the disk plane (FIG. 1) and the anti-cavitation valve is arranged perpendicularly to the disk plane so that the valve disk can be manufactured with a minimum effort due to the simple passage guiding.

In this variant it is preferred when also the axis of the LUDV pressure compensator downstream of the metering orifice of the distribution valve extends in the disk plane.

In an embodiment having a particularly compact design the axis of the individual pressure compensator is arranged centrally between the axes of the two pilot valves so that the valve disk has an almost axially symmetrical structure.

In this variant it is preferred when the axis of the two anti-cavitation valves is arranged in the area which is encompassed by the axis of the two stop valves, the two axes of the pilot valves and the axis of the distribution valve.

For actuating the pilot valve the slide valve of the distribution valve has an operating portion by which a tappet guided perpendicularly to the distribution valve axis is axially movable for controlling the pilot valve to be opened. In a preferred embodiment of the invention this tappet is guided in a portion of the valve disk or the valve housing.

In a particularly compact embodiment the axis of the pilot valve intersects the axis of the respective allocated stop valve.

The mounting of the anti-cavitation valves is especially simple when in the area of these anti-cavitation valves working passages leading to the consumer connections are located in a plane which is arranged offset with respect to a plane of the valve disk including a reservoir passage.

Other advantageous further developments of the invention constitute the subject matter of further subclaims.

Hereinafter a preferred embodiment of the invention will be illustrated in detail by way of schematic drawings in which:

FIG. 1 shows a schematic sectional view of a valve disk comprising the control arrangement according to the invention;

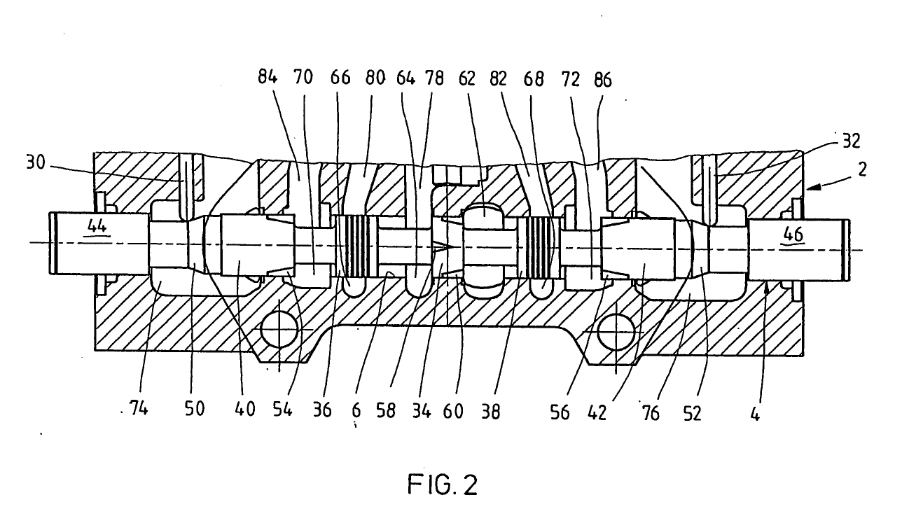

FIG. 2 shows a detailed representation of a distribution valve of the valve disk from FIG. 1;

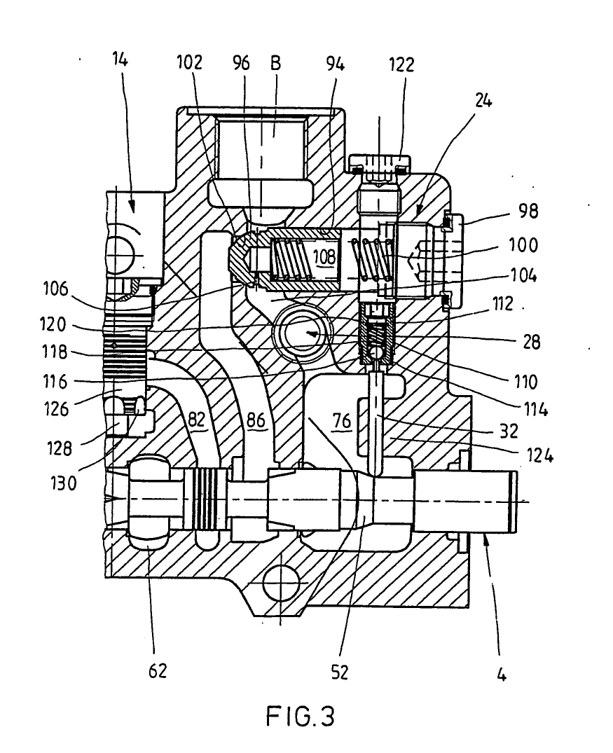

FIG. 3 is a detailed representation of a stop valve, a pilot valve and a pressure compensator of the distribution valve from FIG. 1 and

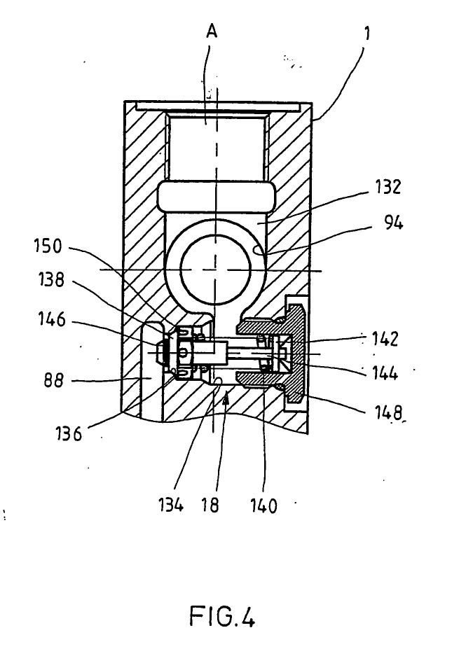

FIG. 4 is a cut side view of the valve disk from FIG. 1 including a pressure/anti-cavitation valve.

FIG. 1 shows a section across a valve disk 1 of a control block of a mobile working implement, for instance a dipper dredger, wherein the valve elements for each function (for example traveling drive, lifting/lowering, operating the shovel etc.) are each combined in a valve disk. The valve disk 1 shown in FIG. 1 has two consumer connections A, B and a pressure connection P (not shown), a reservoir connection T (not shown) as well as plural control connections (inter alia an LS connection). In the valve disk 1 a continuously variable distribution valve 2 is provided including a slide valve 4 which is guided to be axially movable in an axial bore 6 passing through the valve disk 1 in the transverse direction. As explained in more detail hereinafter, the slide valve 4 together with the axial bore 6 forms a velocity member, which is also referred to as metering orifice 8, and two directional members 10, 12 via which the direction of the pressure medium flow from and to the consumer connections A, B is defined.

Downstream of the metering orifice an individual pressure compensator 14 (LUDV pressure compensator) is provided to which in the opening direction the pressure downstream of the metering orifice 8 is applied and in the closing direction the force of a not shown control spring and the maximum load pressure of the consumers is applied. This load pressure is tapped off via a load pressure detecting line 16 and is signaled to the spring chamber of the pressure compensator. Under certain circumstances the control spring can also be dispensed with.

In the valve disk 1 moreover two stop valves 18, 20 each allocated to a consumer connection A, B are arranged via which the consumer connections A, B can be shut off in an oil-leakage free manner. In order to permit a reflux each stop valve 18, 20 can be released by means of a pilot valve 22, 24. In the embodiment represented in FIG. 1 the axes of these pilot valves 22, 24 extend perpendicularly to the axis of the distribution valve 2 and the common axis of the two stop valves 18, 20, the axes of the pilot valves 22, 24 intersecting the axis of the allocated distribution valve 18 and 20, respectively. Each of the pilot valves 22, 24 is actuated via a tappet 30, 32 which is axially movable by the slide valve 4.

Perpendicularly to the plane of projection in FIG. 1, in the valve disk 1 two further pressure/anti-cavitation valves 26, 28 are inserted which control a connection to the reservoir connection T to be opened when a predetermined pressure at the consumer connection A, B is exceeded and which permit feeding of pressure medium from the reservoir in the case of a lacking supply of pressure medium. According to FIG. 1, the two axes of the pressure/anti-cavitation valves 26, 28 are located inside the area formed by the common axis of the two stop valves 18, 20, the axis of the distribution valve 2 as well as the two axes of the pilot valves 22, 24.

The individual pressure compensator 14 as well as the stop valves 18, 20, the pilot valves 22, 24 and the pressure/anti-cavitation valves 26, 28 are inserted in valve bores of the valve disk 1 which are bored from outside, i.e. from the end faces (pressure compensator, pilot valves, stop valves) or from the large area of the valve disk 1 (pressure/anti-cavitation valves) and are shut off after inserting the respective valve bodies by screw plugs or the like.

Further details of the valve arrangement will be illustrated hereinafter by way of the detailed representations.

FIG. 2 shows the distribution valve 2 of the valve disk 1.

The slide valve 4 includes a plurality of annular grooves by which it is subdivided into a central metering orifice collar 34, two control collars 36, 38 arranged on both sides thereof and two reservoir collars 40, 42 arranged laterally thereof. The two end portions 44, 46 project from the valve disk 1. In this area, housings which accommodate the centering springs for the slide valve 4 or control members are flanged to the valve disk.

The annular end faces of the two reservoir collars 40, 42 located externally in FIG. 2 are in the form of inclined control faces 50, 52 against which the tappet 30 and/or 32 is not biased in the central position of the control slide. The two other annular end faces of the reservoir collar 40, 42 are provided with control notches 54, 56. In a similar way fine control notches 58, 60 also end in the annular faces of the central metering orifice collar 34.

The non-represented pressure connection P opens into a pressure chamber 62 which is formed by an annular groove of the axial bore 6. In addition to this pressure chamber 62, the axial bore is further extended to a connecting chamber 64, two annular chambers 66, 68, two outlet chambers 70, 72 as well as two external reservoir chambers 74, 76. Between each of the aforementioned chambers there remain lands which cooperate with the control edges of the slide valve 4.

According to FIG. 1 and FIG. 2 the connecting chamber 64 opens into a pressure compensator passage 78 leading to the inlet of the individual pressure compensator 14. The outlet of the individual pressure compensator is connected to the annular chambers 66, 68 via two passages 80, 82. Each of the two outlet chambers 70, 72 opens into a consumer passage 84, 86 extending toward the inlet of the stop valves 18 and 20, respectively.

In each of the two reservoir chambers 74, 76 a reservoir chamber 88, 90 (cf. FIG. 1) opens which leads to the corresponding pressure/anti-cavitation valve 26, 28.

In FIG. 3 that part of the valve disk 1 is represented in which the stop valve 20 and the pilot valve 24 as well as a part of the individual pressure compensator 14 are housed. The stop valve 20 has a stop piston 96 which is guided to be axially movable in a stop valve bore 94. The latter is shut off by a screw plug 98 supporting a spring 100 via which the stop piston 96 is biased against a valve seat 102. The stop piston 96 is designed to have a seat difference. In the shown locking position the connection between the consumer passage 86 and a working passage 104 connected to the consumer connection B is closed.

This working passage 104 extends from the consumer connection B to the pressure/anti-cavitation valve 28.

In the shell of the stop piston 96 a nozzle 106 is provided by which a spring chamber 108 accommodating the spring 100 is connected to the operating passage 104. This spring chamber 108 can be relieved via the pilot valve 24 toward the reservoir T. The pilot valve includes a seat lining 110 inserted in a bore 112. In the valve lining 110 a pilot seat 114 is formed against which a valve body 116 is biased by means of a pilot spring 118. The latter is supported on a circlip 120 inserted in the lining 110. As one can take especially from FIG. 3, the bore 112 intersects the stop valve bore 64, wherein in the representation according to FIG. 3 the valve lining 110 is inserted with the valve body 116 and the pilot spring 118 in an area of the bore 112 which is arranged opposite to the stop valve bore 94. The opening area of the bore 112 distant from the valve lining 110 is shut off by a screw plug 112. The axis of the bore 112 extends coaxially with respect to the axis of the tappet 82 guided in a guide projection 124 of the valve disk 1. The bore 112 ends in the reservoir chamber 76 so that the end portion of the tappet 32 located on the top in FIG. 3 can dip into the opening encompassed by the pilot seat 114 and can be brought into contact with the valve body 116.

The pressure compensator piston 126 is biased with an axial projection 128 against a wall of the pressure compensator passage 78 and at the adjacent annular front includes control notches 130 constituting a control edge by which the connection between the pressure compensator passage 78 and the passages 80, 82 can be opened.

The pressure-limiting valve is a unit. The pressure spring presses on the seat element 138 and the disk 142 which is positively connected to 144 and 146.

The elements 144 and 146 are one component. The tapered end of 146 is pulled by the pressure spring to the internal seat in 138. The tapered spring 200 presses the entire unit 138 onto the seat in the housing.

FIG. 4 shows a cut side view in the area of the pressure/anti-cavitation valve 26. The consumer connection A opens into a working passage 132. The latter (corresponding to the working passage 104 of the working connection B) leads to a radial connection of the pressure/anti-cavitation valve 18. This valve is inserted in an anti-cavitation bore 134 through which the working passage 132 can be connected to the reservoir passage 88. By the anti-cavitation bore 134 an anti-cavitation valve seat 136 is formed against which an anti-cavitation cone 138 is biased via a pressure spring 140. This spring is supported on a spring plate 142 which, in turn, is mounted on a piston rod 144 of a pressure-limiting piston 146 guided in the anti-cavitation cone 138. The piston rod 144 including the spring plate 142 is supported on a supporting screw 148 which is screwed into the anti-cavitation bore 134 from a large area of the valve disk 1. In the anti-cavitation cone 138 a seat for the pressure-limiting piston 146 is provided against which the latter is biased by the force of the pressure spring 140. The pressure in the spring chamber of the pressure/anti-cavitation valve 26 is signaled to the seat for the pressure-limiting piston 146 via pressure bores 150 of the anti-cavitation cone 138. When a predetermined maximum pressure is exceeded in the working passage 132, the pressure-limiting piston 146 lifts off the seat against the force of the pressure spring 140 and against the pressure acting on the pressure-limiting piston 146 in the reservoir passage 88 to the left (FIG. 4) so that pressure medium can flow from the working passage 132 into the reservoir passage 88—the pressure in the working passage 132 thus being restricted to the maximum value. In the case of a lacking supply, in the reservoir passage 88 a higher pressure is prevailing than in the working passage 132 so that the anti-cavitation cone 138 can lift off its anti-cavitation valve seat 136 against the force of the pressure spring so that pressure medium can flow from the reservoir into the working passage 132, sufficient supply with pressure medium is ensured and cavitation cannot occur.

The structure according to the invention having a design symmetrical in the representation according to FIG. 1 with respect to the axis of the individual pressure compensator 14 and the intersecting axes of the stop valve 18, 20 and the allocated pilot valve 22, 24 and the pressure/anti-cavitation valves 26, 28 arranged perpendicularly thereto permits to combine all hydraulic components required for a LUDV control and a leakage-free support of a consumer in a minimum space.

For a better comprehension of the invention, hereinafter the function of the control arrangement 1 according to the invention will be briefly explained. It is assumed that the slide valve 4 of the distribution valve 2 is moved to the right in the representation according to FIG. 1 so as to pass pressure medium via the consumer connection A to the consumer and from the latter via the consumer connection B back to the reservoir T. By the axial displacement of the slide valve 4 to the right a metering orifice cross-section is controlled to be opened via the control notches 58 of the metering orifice collar 34 so that pressure medium can flow from the pressure chamber 62 into the pressure compensator passage 78. With a sufficient pump pressure the pressure compensator is moved to an opening position by the pressure effective in the opening direction so that the pressure medium can flow via the passage 80 and the annular chamber 66 into the opened outlet chamber 70. From there the pressure medium passes via the consumer passage 84 to the inlet of the stop valve 18. With a sufficient pressure in the consumer passage 84 the stop piston 96 of the stop valve 18 is lifted off its valve seat 102 against the force of the spring 100 so that the pressure medium is supplied toward the consumer A. The load pressure building up at the consumer is signaled via the LS passage 74 to the spring chamber of the individual pressure compensator 14. This compensator adjusts a control position in which the pressure drop is kept constant above the inlet metering orifice.

At the same time, the tappet 32 is displaced upwards via the control surface 52 in the axial direction (view according to FIG. 1) by the axial movement of the slide valve 4 to the right so that the valve body 116 is lifted off its pilot seat 114 and the spring chamber 108 of the stop valve is correspondingly relieved toward the reservoir chamber 76. The pressure prevailing at the working connection B then suffices to lift the stop piston 96 off its valve seat 102 against the force of the spring 100 so that the pressure medium can flow from the working connection B via the consumer passage 86 and the discharge cross-section opened by the reservoir collar 42 including the control notches 56 into the reservoir chamber 76 and from there to the reservoir.

In the event in which a pulling load occurs (for instance when pouring out or lowering a load) it may happen that not sufficient pressure medium is fed to the working connection A so that the pressure at this connection falls below the pressure in the outlet. In other words, the inlet pressure falls below the reservoir pressure so that the pressure/anti-cavitation valve is opened in the above-described manner and pressure medium can continue to flow from the reservoir passage 88 into the working passage 132.

A hydraulic control arrangement is disclosed for the load pressure independent control of a consumer, comprising a distribution valve forming an inlet metering orifice, a corresponding individual pressure compensator, a stop valve provided for each consumer connection which may be released by means of a pilot valve and an anti-cavitation valve by means of which pressure medium can be drawn from a reservoir to avoid cavitation. According to the invention, the distribution valve and the stop valves are arranged along two parallel axes, while the axes of the two pilot valves are arranged perpendicularly to these two axes. The anti-cavitation valves in turn extend perpendicularly to the axes of the distribution valves, the stop valves and the anti-cavitation valves.

### LIST OF REFERENCE NUMERALS

1 Valve disk

2 distribution valve

4 slide valve

6 axial bore

8 metering orifice

10 directional member

12 directional member

14 individual pressure compensator

16 LS passage

18 stop valve

20 stop valve

22 pilot valve

24 pilot valve

26 pressure/anti-cavitation valve

28 pressure/anti-cavitation valve

30 tappet

32 tappet

34 metering orifice collar

36 control collar

38 control collar

40 reservoir collar

42 reservoir collar

44 end portion

46 end portion

50 control surface

52 control surface

54 control notch

56 control notch

58 fine control notch

60 fine control notch

62 pressure chamber

64 connecting chamber

66 annular chamber

68 annular chamber

70 outlet chamber

72 outlet chamber

74 reservoir chamber

76 reservoir chamber

78 pressure compensator passage

80 passage

82 passage

84 consumer passage

86 consumer passage

88 reservoir passage

90 reservoir passage

94 stop valve bore

96 stop piston

98 screw plug

100 spring

102 valve seat

104 working passage

106 nozzle

108 spring chamber

110 valve lining

112 bore

114 pilot seat

116 valve body

118 pilot spring

120 circlip

122 screw plug

124 guide projection

126 pressure compensator piston

128 axial projection

130 control notches

132 working passage

134 anti-cavitation bore

136 anti-cavitation valve seat

138 anti-cavitation cone

140 pressure spring

142 spring plate

144 piston rod

146 pressure limiting piston

148 supporting screw

150 pressure bores

1. A hydraulic control arrangement for the load pressure independent control of a consumer, comprising a housing portion, preferably a valve disk in which a continuously variable distribution valve controlling the pressure medium flow to the consumer is accommodated to which distribution valve an individual pressure compensator is allocated, and comprising at least one stop valve which is arranged in the pressure medium flow path between the distribution valve and the consumer and can be released to permit a pressure medium flow from the corresponding consumer connection, and comprising an anti-cavitation valve via which pressure medium can be sucked from the reservoir in the case of a lacking supply of the consumer, characterized in that the stop valve is controlled by a pilot valve the axis of which extends perpendicularly to the axis of the distribution valve and of the stop valve arranged axially parallel thereto, wherein the pilot valve can be controlled to be opened mechanically by a slide valve of the distribution valve, and that the axis of the pressure-limiting and anti-cavitation valve extends perpendicularly to the axes of the distribution valve and the pilot valve.

2. A hydraulic control arrangement according to claim 1, wherein the control arrangement is accommodated in a valve disk and the distribution valve, two stop valves and pilot valves are arranged in the disk plane and the pressure-limiting and anti-cavitation valves are arranged perpendicularly to the disk plane.

3. A control arrangement according to claim 1, wherein the axis of the individual pressure compensator is arranged perpendicularly to the axis of the distribution valve in the disk plane.

4. A control arrangement according to claim 3, wherein the axis of the individual pressure compensator is arranged centrally between the axes of the two pilot valves.

5. A control arrangement according to claim 1, wherein the axis of the pilot valves intersects the axis of the corresponding stop valve in the area of a spring chamber.

6. A control arrangement according to claim 1, wherein the axis of the pressure-limiting and anti-cavitation valves is located in the area between a common axis of the stop valves and the axis of the distribution valve.

7. A control arrangement according to claim 1, wherein the slide valve includes a control surface via which a tappet extending perpendicularly to the axis of the distribution valve is axially movable for opening the pilot valve.

8. A control arrangement according to claim 7, wherein the tappet is guided in the valve disk.

9. A control arrangement according to claim 2, wherein each of the stop valve and the pilot valve are accommodated in intersecting bores ending at the side faces of the valve disk.

10. A control arrangement according to claim 1, wherein at least in the area of the pressure-limiting and anti-cavitation valves working passages leading to the consumer connections are located in a plane of the valve disk which is arranged offset with respect to a plane including reservoir passages.
